(19) United States
(12) Patent Application Publication
(10) Pub. No.: US 2009/0249327 A1
(43) Pub. Date: Oct. 1, 2009

(54) METHOD FOR METERING AN EXTENSIBLE LICENSE FOR JAVA APPLICATIONS

(75) Inventors: Giorgio Cognigni, Rome (IT); Bernardo Pastorelli, L'Aquila (IT)

Correspondence Address: ZILKA-KOTAB, PC- IBMS, P.O. BOX 721120, SAN JOSE, CA, 95172-1120, US

(73) Assignee: International Business Machines Corporation, Armonk, NY (US)

(21) Appl. No.: 12/060,168

(22) Filed: Mar. 31, 2008

(51) Int. Cl. G06F 9/445

(52) U.S. Cl. 717/174

(57) ABSTRACT

A method in one embodiment includes using a class loader, detecting an entry point to a Java application; using a class loader, detecting each entry point extension to the Java application; and contacting a third party license server for acquiring a license for each of the Java application and extension associated with each detected entry point.

### BACKGROUND OF THE INVENTION

The present invention relates to acquiring and managing licenses and license extensions for extensible JAVA applications.

Currently, extensible JAVA applications manage licenses for any extensions at installation lime or by embedding specialized licensing code inside of each extension. Therefore, it would be favorable to allow implementation of licensing schemes without requiring substantial changes to the extensions themselves.

### SUMMARY OF THE INVENTION

A method in one embodiment includes using a class loader, detecting an entry point to a Java application; using a class loader, detecting each entry point extension to the Java application; and contacting a third party license server for acquiring a license for each of the Java application and extension associated with each detected entry point. Any of these embodiments may be implemented individually or in conjunction with any other system or method.

Other aspects, advantages and embodiments of the present invention will become apparent from the following detailed description, which, when taken in conjunction with the drawings, illustrate by way of example the principles of the invention.

### BRIEF DESCRIPTION OF THE DRAWINGS

FIG. 1 shows a flow chart of a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and tire appended claims, the singular forms “a,” “an” and “the” include plural referents unless otherwise specified.

The following description discloses several preferred embodiments of methods for license managing JAVA applications and their extensions.

In one general embodiment, a method comprises using a class loader, detecting an entry point to a Java application; using a class loader, detecting each entry point extension to the Java application; and contacting a third party license server for acquiring a license for each of the Java application and extension associated with each detected entry point.

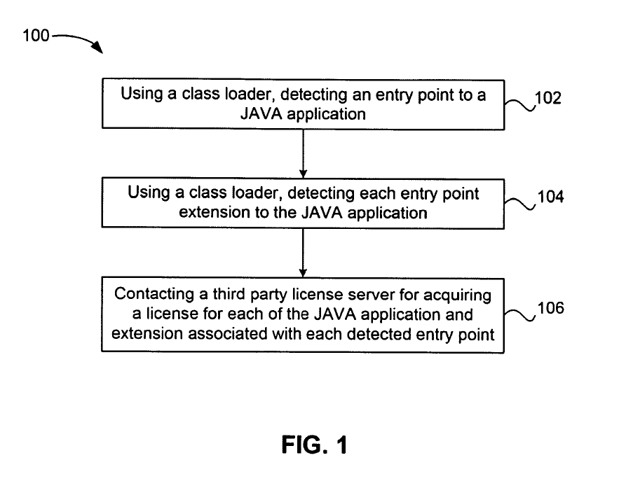

FIG. 1 illustrates a method 100 according to one embodiment. As an option, the method 100 may be carried out in any desired environment. It should be noted that the aforementioned definitions may apply during the present description.

With continued reference to FIG. 1, in operation 102, using a class loader, an entry point to a JAVA application is detected. For example, when a JAVA application is started, it may require licensing management for itself and its extensions, and die entry point to the JAVA application can serve as a marker.

In operation 104, using a class loader, each entry point extension to the JAVA application is detected. Once again, for example, when a JAVA extension is started, it may require licensing management for itself and any subsequent extensions, and the entry point extension to the JAVA application can serve as a marker. For example, a marker may include a PluginInterface. All the classes implementing this PluginInterface are indications that a licensed extension is being loaded.

In operation 106, a third party license server is contacted for acquiring a license for each of the JAVA application and extension associated with each detected entry point. For example, a license for the JAVA application might be requested from the license server before the JAVA application will start. With continued exemplary reference, a license extension for each extension or plugin might be requested from the license server before the extension or plugin will start. To further the example, a request may be made to the license server for each mark that is detected if the JAVA application and extension or plugins are marked for each entry point.

It will also be clear to one skilled in the art that the method of the present invention may suitably be embodied in a logic apparatus comprising logic to perform various steps of the methodology presented herein, and that such logic may comprise hardware components or firmware components.

It will be equally clear to one skilled in the art that the logic arrangement in various approaches may suitably be embodied in a logic apparatus comprising logic to perform various steps of the method, and that such logic may comprise components such as logic gates in, for example, a programmable logic array. Such a logic arrangement may further be embodied in enabling means or components for temporarily or permanently establishing logical structures in such an array using, for example, a virtual hardware descriptor language, which may be stored using fixed or transmittable carrier media.

It will be appreciated that the methodology described above may also suitably be carried out fully or partially in software running on one or more processors (not shown), and that the software may be provided as a computer program element earned on any suitable data carrier (also not shown) such as a magnetic or optical computer disc. The channels for the transmission of data likewise may include storage media of all descriptions as well as signal carrying media, such as wired or wireless signal media.

Embodiments of the present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part, of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

Communications components such as input/output or I/O devices (including but not limited to keyboards, displays, pointing devices, etc.) can be coupled to the system either directly or through intervening I/O controllers.

Communications components such as buses, interfaces, network adapters, etc. may also be coupled to the system to enable the data processing system, e.g., host, to become coupled to other data processing systems or remote printers or storage devices through intervening private or public networks. Modems, cable modem and Ethernet cards are just a few of the currently available types of network adapters.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method, comprising:
using a class loader, detecting an entry point to a Java application;
using a class loader, detecting each entry point extension to the Java application; and
contacting a third party license server for acquiring a license for each of the Java application and extension associated with each detected entry point.
